(19) United States
(12) Patent Application Publication
(10) Pub. No.: US 2024/0394171 A1
(43) Pub. Date: Nov. 28, 2024

(54) METHOD, DEVICE, APPARATUS AND STORAGE MEDIUM FOR CODE PARAMETER VERIFICATION

(71) Applicant: Beijing Volcano Engine Technology Co., Ltd., Beijing (CN)

(72) Inventors: Xu Duan, Beijing (CN); Huan Song, Beijing (CN); Yannan Liu, Beijing (CN); Jie Liu, Beijing (CN)

(21) Appl. No.: 18/671,290

(22) Filed: May 22, 2024

(30) Foreign Application Priority Data
May 22, 2023 (CN) 202310584013.7

(51) Int. Cl. G06F 11/36

(52) U.S. Cl. CPC G06F 11/3608

(57) ABSTRACT

According to embodiments of the present disclosure, there are provided a method, an apparatus, a device and a storage medium for code parameter verification. In a method, a parameter verification request for target code is detected; in response to detecting a parameter verification statement, at least one code segment is extracted from the target code that matches at least one predetermined statement type of a plurality of predetermined statement types; and a verification statement for at least one parameter of the target code is generated, with a trained machine learning model, based on the at least one code segment, the verification statement being configured to verify validation of the at least one parameter, where the machine learning model is trained based on a sample code set and sample verification statement for parameters of sample code in the sample code set.

### CROSS REFERENCE

The present application claims priority to Chinese Patent Application No. 202310584013.7 filed on May 22, 2023, and entitled “METHOD, DEVICE, APPARATUS AND STORAGE MEDIUM FOR CODE PARAMETER VERIFICATION”, which is incorporated herein by reference in its entirety.

### FIELD

Example embodiments of the present disclosure generally relate to the field of computers, and in particular, to a method, an apparatus, a device and a computer-readable storage medium for code parameter verification.

### BACKGROUND

Code verification is a verification performed to avoid errors and omissions that may occur with code designs and inputs. It can be verified with a program, with a verification tool, or even manually. The code verification may find a problem that does not comply with standards in advance, thereby improving the robustness of the developed software.

### SUMMARY

In a first aspect of the present disclosure, a method of code parameter verification is provided. The method comprises: detecting a parameter verification request for a target code: in response to detecting the parameter verification request, extracting at least one code segment from the target code that matches at least one of a plurality of predetermined statement types: and generating, based on the at least one code segment, a verification statement for at least one parameter of the target code with a trained machine learning model, the verification statement being configured to verify validation of the at least one parameter, where the machine learning model is trained based on a sample code set and sample verification statements for parameters of sample code in the sample code set.

In a second aspect of the present disclosure, an apparatus for code parameter verification is provided. The apparatus comprises: a request detection module configured to detect a parameter verification request for target code: an extraction module configured to extract at least one code segment from the target code that matches at least one of a plurality of predetermined statement types: and a generation module configured to generate, based on the at least one code segment, a verification statement for at least one parameter of a target code with a trained machine learning model, the verification statement being configured to verify validation of the at least one parameter, where the machine learning model is trained based on a sample code set and sample verification statements for parameters of sample code in the sample code set.

In a third aspect of the present disclosure, an electronic device is provided. The device comprises at least one processing unit: and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer readable storage medium is provided. The computer readable storage medium has a computer program stored thereon, when executed by a processor implements the method of the first aspect.

It would be appreciated that the content described in the section is neither intended to identify the key features or essential features of the present disclosure, nor is it intended to limit the scope of the present disclosure. Other features of the present disclosure will be readily understood through the following description.

### BRIEF DESCRIPTION OF THE DRAWINGS

The above and other features, advantages, and aspects of the various embodiments of the present disclosure will become more apparent in combination with the accompanying drawings and with reference to the following detailed description. In the drawings, the same or similar reference symbols refer to the same or similar elements, wherein:

FIG. 1 illustrates a schematic diagram of an example environment in which embodiments of the present disclosure can be implemented;

FIG. 2 illustrates a flowchart of a method of code parameter verification according to some embodiments of the disclosure;

FIG. 3 illustrates a schematic diagram of an inference process of a machine learning model according to some embodiments of the disclosure;

FIG. 4 illustrates a schematic diagram of an inference and training process of a machine learning model according to some embodiments of the disclosure;

FIGS. 5A and 5B illustrate schematic diagrams of example code of a complementary verification statement according to some embodiments of the disclosure;

FIG. 6 illustrates a block diagram of an apparatus for code parameter verification, according to some embodiments of the disclosure; and

FIG. 7 illustrates a block diagram of a device capable of implementing various embodiments of the present disclosure.

### DETAILED DESCRIPTION

It will be appreciated that the data involved in this technical solution (comprising but not limited to the data itself, data acquisition or use) shall comply with the requirements of corresponding laws, regulations, and relevant provisions.

As used herein, the term “in response to” represents a state in which a corresponding event occurs, or a condition is satisfied. It will be understood that there may not be a strong correlation between the timing of the execution of a subsequent action that is executed in response to the event or condition and the time when the event or condition is established. For example, in some cases, the subsequent action may be executed immediately upon the occurrence of the event or the establishment of the condition: while in other cases, the subsequent action may be executed a period of time has passed since the event occurred or the condition was established.

The embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

In the description of the embodiments of the present disclosure, the term “comprising”, and similar terms would be appreciated as open inclusion, that is, “comprising but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

As used in this specification, the term “model” can learn a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used herein, “model” may also be referred to as “machine learning model”, “machine learning network”, or “network”, and these terms are used interchangeably herein. A model may also include different types of processing units or networks.

As used herein, “unit”, “operational unit”, or “subunit” may consist of any suitably structured machine learning model or network. As used herein, a set of elements or similar expressions may include one or more of such elements. For example, “a set of convolution units” may comprise one or more convolution units.

As mentioned briefly above, although code can be written according to standards to reduce development and debug time, code verifications are still very important in programming. The verification missing is one of common causes, which refers to the missing of security checks on the validation of key parameters, resulting in illegal requests for data that are not correctly intercepted, and further lead to unintended consequences, such as serious damage to business assets and data security issues.

The verification missing causes multiple hazards, and generally exists in multiple business scenarios. For example, in some cases, there is a privilege bypass problem, in which an attacker can overstep the authority to obtain other people's information. For example, in an e-commerce business scenario, a failure to verify the owner of an order may lead to information leakage due to unauthorized access to other people's orders. In other cases, it is possible that due to a failure to verify the uploaded file types, attackers may upload harmful files such as viruses and Trojan horses to control the victim's host and illegally collect specific data. In some other cases, due to the validation of Structured Query Language (SQL) statements being not verified, an attacker may construct an abnormal SQL statement to spoof a server, thereby implementing unauthorized illegal query and leading to data leakage, and so on. The above problems are widely distributed, and are very common risk types in an enterprise software development life cycle (SDLC).

Current Automated Program Repair (APR) techniques mainly aim at a program bug problem, and achieve automatically location and repair without human intervention. However, such techniques typically have the following problems, causing them unsuitable for repairing “missing verification”. The program automatic repair technology does not have the automatic repair capability for the security problem, such as the verification missing, tightly coupled with the business logic. For example, “Null Pointer Dereference” is a common program bug, which refers to a situation that when a pointer points to an invalid memory area, the pointer still reference the area, resulting in a memory error and a software system crash. Compared with such common program bugs, “verification missing” is often defined by the business expected logic, which may satisfy the requirement of running the code, and therefore cannot be found by the APR techniques. For example, in an e-commerce business scenario, the business expected logic is that an ordinary user has no permission to access to other users' order information, and therefore if a verification statement of a user permission is missing in a code at this moment, an overstepping hazard may be caused. In this scenario, the APR technique cannot effectively understand and identify the business scenario that requires verification, and therefore cannot achieve automatic repair of a defect.

Some automatic program repair techniques may be mainly categorized into template-based, heuristic algorithm-based, constraint-based, and deep learning-based approaches. Currently, the most advanced approach is a deep learning-based approach, which mainly rely on a traditional neural network model such as a Long Short-Term Memory (LSTM) to learn a rule from an existing program bug and repair data and automatically generate an error patch. However, such technologies are limited by the number of parameters and data completeness and/or the like, and cannot be effectively adapted to various types of complex business scenarios. For example, such approaches cannot accurately generate patches in a single prediction, which typically need to generate multiple candidate patches at the same time and repair the errors by verifying them one by one. In real engineering practice, there is room for improving the practicality of such approaches.

To this end, embodiments of the present disclosure proposes an improved solution for code parameter verification, which uses a machine learning model to assist ain automatic completion of a verification statement. According to various embodiments of the present disclosure, in response to a parameter verification request for target code, at least one code segment that matches at least one of a plurality of predetermined statement types is extracted from the target code. With a trained machine learning model, a verification statement for at least one parameter of the target code is generated based on the at least one code segment. The verification statement is configured to verify the validation of at least one parameter. The machine learning model used is trained based on a sample code set and sample verification statement for the parameter of the sample code in the sample code set. Thus, automatic recognition and repair of the problem of the verification missing in the code can be achieved. In this way, the condition of the parameter verification missing in the code can be detected in time, and the verification statement can be completed in time to avoid security vulnerabilities.

Further, some embodiments of the present disclosure also attempt to apply a language model and a pre-training strategy at a code intelligence task by selecting an appropriate training data set, designing an appropriate architecture and a training scheme, and combining structure information of the code itself to implement a code completion task using a machine learning model. In this way, the machine learning model is enabled to learn the semantics of the code language in various scenarios and how to perform the verification task. A machine learning model with this knowledge is applied to identify the business scenarios that need to verify and automatically complete the verification statements.

Example embodiments of the present disclosure are described below with reference to the accompanying drawings.

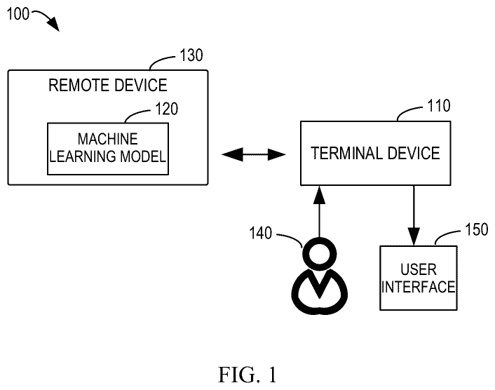

FIG. 1 shows a schematic diagram of an example environment 100 in which embodiments of the present disclosure can be implemented. In the environment 100, a terminal device 110 may be used to provide code editing, debugging, verification, access, and/or the like to a user 140. The terminal device 110 provides a user interface 150. The user interface 150 includes, for example, a code editing page to support the user 140 in developing, debugging, verifying, etc., code on the user interface 150, either directly or via an attached device connected to the terminal device 110. The user interface 150 may also include any interface that provides access to the code, code files, and/or the like.

In embodiments of the present disclosure, code parameter verifications are performed with a machine learning model 120. In the example of FIG. 1, the machine learning model 120 used may be deployed at a remote device 130. The terminal device 110 may communicate with a remote device 130 (e.g., via network communication) to perform model inference tasks using the machine learning model 120 stored thereon. In other embodiments, the machine learning model 120 may also be partially or fully deployed locally at the terminal device 110. The embodiments of the present disclosure are not specifically limited in this regard.

The terminal device 110 may be any type of mobile terminals, fixed terminals, or portable terminals including a mobile handset, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a position device, a television receiver, a radio broadcast receiver, an electronic book device, a game device, or any combination of the foregoing, including accessories and peripherals for these devices, or any combination thereof. The remote device 130 may include, for example, a computing system/server, such as a mainframe, an edge computing node, a computing device in a cloud environment, a virtual machine, and/or the like. Although a single device is shown, the remote device 130 may include a plurality of physical devices. In addition, while only a single terminal device is shown, the remote device 130 or the machine learning model deployed therein may be accessed by a plurality of terminal devices to provide inference capabilities of the machine learning model 120.

It should be understood that the structure and functionality of the environment 100 are described only for the purpose of illustrations and are not intended to imply any limitation on the scope of the present disclosure.

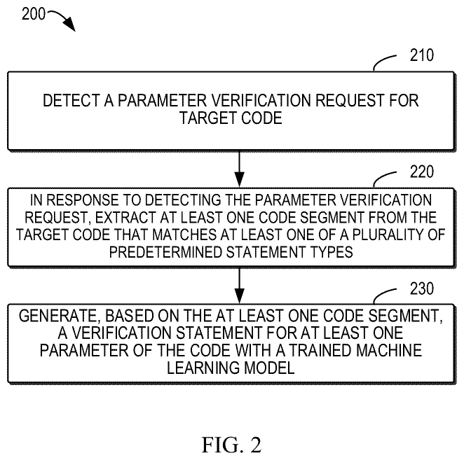

FIG. 2 shows a flowchart of a method 200 for code parameter verification according to some embodiments of the present disclosure. The method 200 may be implemented in the example environment 100. for example at the terminal device 110. The method 200 will be described below with reference to FIG. 1.

At block 210, the terminal device 110 detects a parameter verification request for the target code. As described in detail below, in an embodiment of the present disclosure, an automatic detection and completion scheme for code verification missing is provided to determine whether the parameter validation in the code needs to be verified, and generate a corresponding verification statement. In some embodiments, the present disclosure proposes verification missing detection and completion that may support verification of the code that is being edited. In some embodiments, the verification missing detection and completion proposed in the present disclosure may also support the verification missing detection and completion for code that has been completed for editing and the underlying code of the packaged application/software.

In some embodiments, the terminal device 110 may detect a parameter verification request in a code editing page of the target code. For example, a code developer may be allowed to initiate a parameter verification request during code development, for example, while the code is being edited. In this way, the presence of a verification missing may be easily and conveniently confirmed at any time during code editing. In some embodiments, the terminal device 110 may receive a parameter verification request initiated for a code file of the target code. For example, the code file may be generated after the code editing is completed. In this way, existing code, applications, or software, etc., may be verified to check if there may be verification missing, and to make timely completions.

The parameter verification request may be triggered in various suitable manners. The parameter verification request may be triggered manually by the user, or may be triggered automatically. For example, it may be triggered periodically during code editing or based on some predetermined conditions (e.g., detecting that a new parameter is defined). In some embodiments, the parameter verification detection and completion scheme proposed in the present disclosure may be encapsulated as a specific function in code development, editing, and verifying processes. For example, it may be encapsulated as an integrated development environment (IDE) plug-in. The parameter verification request may be initiated by triggering on the IDE plug-in. In addition, the parameter verification request may also be triggered in a manner such as voice instruction triggering or clicking on a predetermined control.

At block 220, in response to detecting the parameter verification request, the terminal device 110 extracts at least one code segment from the target code. Each code segment matches one or more predetermined statement types of the plurality of predetermined statement types. Each code segment may also be referred to as a “statement block”, which may include one or more lines of code.

The predetermined statement type thus selected may be a code statement in the target code that is considered potentially able to help the machine learning model 120 understand the semantics associated with the parameter and facilitate generation of a verification statement for the validation of the parameter. In some embodiments, the predetermined statement types considered in the parameter verification may include, but are not limited to: a parameter fetching statement, a function header, and/or a remote procedure call statement. A parameter fetching statement refers to a statement for obtaining a value of a parameter. For example, the value of the parameter may be obtained by #{key}, and is pre-compiled into an SQL statement; the value of the parameter may also be obtained by ${key}, and is concatenated into an SQL statement. The parameter fetching statement may include a statement that obtains a parameter from a request URL parameter, a request body, and a request header. For example, in the go language, a statement of a request Session is obtained by a Gin framework Context class. A function generally includes a function header and a function body. The function header includes component parts such as a function name, a function type, a function attribute, a function parameter, and a parameter type of the function. Remote Procedure Call (RPC) is also referred as method call or subroutine call. A remote procedure call statement is a statement that calls a downstream service method based on the RPC protocol.

In some embodiments, the terminal device 110 may extract a code segment by function granularity from the target code that matches one or more statement types of a plurality of predetermined statement types. In particular, the terminal device 110 may identify one or more functions defined in the target code, and for each function, determine whether the function includes a code segment that matches one or more statement types of the plurality of predetermined statement types.

At block 230, the terminal device 110 utilizes the trained machine learning model 120 to generate a verification statement for at least one parameter of the target code based on the at least one code segment. The validation statement is configured to verify the validation of the at least one parameter.

The terminal device 110 may generate a verification statement of the parameters with the machine learning model 120. For example, in a code editing interface, the terminal device 110 continuously monitors for predetermined statements in the current editing function of the user 140. The terminal device 110 extracts a code segment matching a predetermined statement type and provides it to the machine learning model 120. The machine learning model 120 may complete a corresponding verification statement, thereby generating a verification statement under the context semantic of the target code. As another example, after the code editing is completed, the terminal device 110 may in response to triggering of the user 140 (for example, by clicking on an IDE plug-in or by a voice instruction), generate a verification statement of a parameter for the code or the code file with the machine learning model 120.

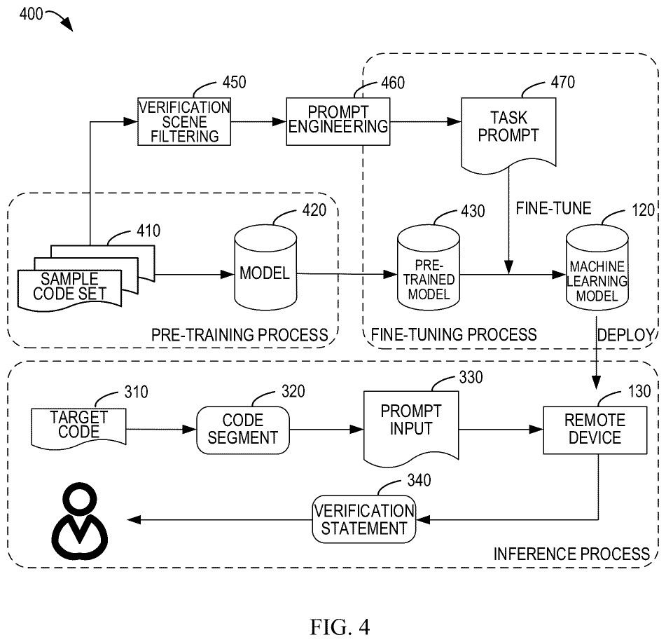

The machine learning model 120 may be obtained based on a sample code set and sample verification statements for parameters of the sample codes in the sample code set. The training process of machine learning model 120 will be described in detail below with reference to FIG. 4.

In a verification completion scenario, a verification statement is used to verify whether a value, a use, and/or the like of a parameter in a code are valid. For example, in a code related to e-commerce business, the parameter to be verified may be “order user ID” to verify whether the order user has access rights. In the code related to file upload, the parameter to be verified may be “the type of uploaded file”, to verify whether the file belongs to a malicious file. In the code related to SQL injection, the parameter may be a “SQL statement” to verify whether the SQL statement is valid.

In some embodiments, after determining the verification statement, the terminal device 110 may present an insert prompt control for the verification statement. If a predetermined operation for the insert prompt control is detected, the terminal device 110 may insert a verification statement into the target code. The insert prompt control is used to prompt the user to insert a verification statement into the target code. In some embodiments, the insert prompt control may include a prompt about an insertable verification statement, and/or may display a parameter to be verified by the verification statement or a specific verification statement. In this way, the user may know and confirm the insertion of the verification statement as required. In some embodiments, the insertion prompt control may include a confirm insertion option, a reject insertion option, an edit option, etc. for the verification statement to be further selected by the user. The insert prompt control may be presented in any suitable form, for example, presented in the form of a pop-up window, in a particular area of the code-editing page, and/or the like.

In some embodiments, after the verification statements generated by the machine learning model 120 and returned to the terminal device 110 by the remote device 130, the terminal device 110 may automatically insert the verification statements into the target code without requiring user confirmation. Certainly, a revocation operation may also be reserved, so that the user revokes the inserted verification statement as required

When determining that the verification statement is to be inserted, the terminal device 110 may determine a target position of the verification statement to be inserted in the target code. Such a target position may include, for example, a position of an input cursor (also referred to as a “cursor position”) or a position specified by a user. The terminal device 110 may insert the verification statement into the target position determined in the target code. For example, after obtaining the verification statement, the terminal device 110 may automatically insert the verification statements into the cursor position, for example, the cursor position in a code editing page. In some embodiments, the position to be inserted may be specified by the user before or after the verification statement is generated. For example, the position to be inserted is selected by the user after the check statements are presented to the user.

According to the embodiments of the present disclosure, automatic and convenient identification and verification completion of the problem of verification missing may be achieved. In some embodiments, based on the machine learning model 120, it may be determined that a plurality of parameters in the target code may be verified, or a plurality of validation statements may be generated. The terminal device 110 may also insert these verification statements into the target code in a similar manner. In some embodiments, the machine learning model 120 determines that no additional verification statements are necessary for the current target code, an indication that the parameter verification is not missing may also be returned.

In some embodiments, when generating a verification statement, in addition to a code segment matching one or more predetermined statement types in a plurality of predetermined statement types, the terminal device 110 may also determine a target position of a verification statement to be inserted in a target code, and extract a further code segment in a predetermined neighborhood of the target position of the target code. In some cases, in addition to considering code segments that match a predetermined statement type, it is also necessary to additionally consider some code segments that are inserted near the target position of the verification statement. These code segments may also indicate useful information for generating a verification statement. For example, in an e-commerce business scenario, when verifying whether a user is the owner of an order in order to prevent the user from obtaining another person's order by overstepping user's authority, the code segments in a predetermined neighborhood are usually more helpful for generating a verification statement for a business scenario or business logic.

As described above, the target position where the verification statement is to be inserted in the target code may include a position of a cursor or a position specified by a user. The predetermined neighborhood of the target position may include a predetermined number of lines of code near the target position. For example, during code editing by the user 140, the predetermined neighborhood may be a number of consecutive lines (e.g., 10 consecutive lines) before the cursor position. Statements that match code segments in such a predetermined neighborhood are also referred to as “cursor precedence statements”. For another example, after the code is compiled, a verification statement is inserted at a certain position in the code by supporting the designation of the user 140, or the verification statement needs to be inserted at a certain position automatically by another tool or approach. In such a scenario, the predetermined neighborhood may include a front consecutive number of rows and a back contiguous number of rows of the specified position (e.g., a front 5 to a back 5 row). Statements that match code segments in such a predetermined neighborhood are also referred to as “statements before and after the specified position”. Further, the terminal device 110 uses the machine learning model 120 to generate a verification statement based on a previously extracted code segment that matches a predetermined statement type and another code segment in a previously extracted predetermined neighborhood.

In some embodiments, generating the terminal device 110 with the machine learning model 120 may obtain the prompt input by combining the extracted code segments and the task prompt, and providing the prompt input to the machine learning model 120 to obtain the verification statement. The task prompt is used to indicate the verification statement generation task. For example, the terminal device 110 inserts “[complete validation]” before or after the extracted code segment as the task prompt. Certainly, it is only an example herein, and any predetermined configuration of characters or character strings may be used as the task prompt of the verification statement generation task. The structure of the prompt input may be, for example, a format of “[complete validation]<x>”, where <x> is the code segment to be provided to the machine learning model 120. The task prompt may be used to explicitly indicate to the machine learning model 120 the task to be completed with the code segment, i.e., determining the generation of a verification statement. In this way, the machine learning model 120 may more accurately return a correct verification statement in a single prediction scenario and may effectively implement a left shift of a verification missing problem.

In some scenarios, if fewer code segments are extracted from the target code that match a predetermined type of statement, and the prompt input provided to the machine learning model 120 is of a fixed size, the terminal device 110 may use the extracted code segments and predetermined symbols (e.g., “0”) to construct <x> in the prompt input.

In some embodiments, in the prompt input, the terminal device 110 may concatenate the plurality of code segments in an order of the plurality of code segments in the target code, and combine the concatenated plurality of code segments and the task prompt. The order of the code segments in the target code is, for example, the natural order in which the code is written, also known as the front-to-back order. Because the statements associated with the code have a front-to-back dependency, preserving such a front-to-back order help the machine learning model 120 to better understand the code semantics. For example, the terminal device 110 continuously monitors predetermined statements in the current editing function of the user 140 and extracts a plurality of code segments matching a predetermined statement type from the target code, and concatenates in a natural order of these code segments in the target code. Further, the terminal device 110 inserts “[complete validation]” as a task prompt before the concatenated plurality of code segments to construct a “[complete validation]<x>” format prompt input.

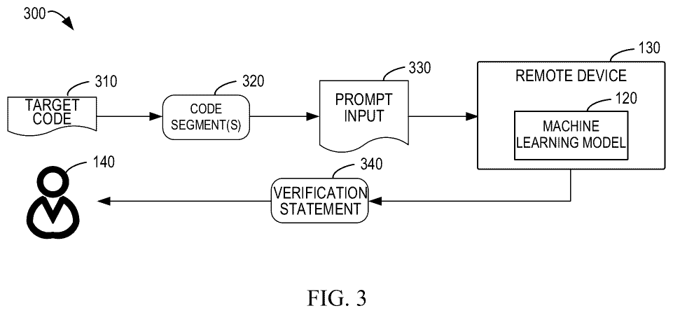

The inference process (also referred to as the application process) of the machine learning model 120 is described above by a plurality of embodiments and in conjunction with the method 200. Typically, the machine learning may broadly comprise three phases, namely a training phase (also referred to as the training process), a testing phase (also referred to as the testing process), and an inference phase (also referred to as the inference process). In the training phase, a given model may be trained using a large amount of training data, iterating until the model is able to derive consistent inferences from the training data that satisfy the desired goal. Through training, the model may be considered to be able to learn associations from inputs to outputs (also known as input-to-output mapping) from the training data. In the testing phase, the performance of the model is determined by applying the test inputs to the trained model and testing whether the model is able to provide the correct outputs. In the inference phase, the model may be used to process the actual inputs to determine the corresponding outputs based on the parameter values obtained from the training. The training process and the inference process of the machine learning model 120 are described in more detail below with reference to FIGS. 3 to 5B.

FIG. 3 shows a schematic diagram of an inference process 300 for a machine learning model 120 according to some embodiments of the present disclosure. Example 300, for example, is a scenario in which a user 140 is developing target code 310. The terminal device 110 automatically triggers an IDE plug-in to continuously monitor for “reference statements”, “function headers”, “RPC call statements”, and “Cursor Procedure Statements” in the target code 310. When the terminal device 110 monitors to these statements, it may extract code segments 320 from the target code 310 that match the above statements in real time or at regular intervals, and the code segments 320 may include one or more code segments. The terminal device 110 concatenates the extracted code segments 320 into a text format in the natural order of the code and inserts a task prompt (e.g., “[complete validation]”) in the first line thereof (or other suitable position) to obtain prompt input 330, e.g., the code segment 320 as well as the task prompt 330 may be stitched together to obtain the prompt input 330 in the format of “[complete validation]<x>”. The prompt input 330 is sent to the remote device 130. The remote device 130 enters the prompt input 330 into the machine learning model 120. The machine learning model 120 receives such content and performs inference to generate a verification statement 340 to be completed with respect to the target code 310. The remote device 130 returns such verification statement 340 to the terminal device 110 of the user 140 to complete the verification statement in real time at the suitable position of the target code 310.

In the inference process 300, the machine learning model 120 is assumed to have completed training. The terminal device 110, using the trained machine learning model 120, may implement the detection and repair of the verification missing of the completion code. The machine learning model 120 may be trained based on a sample code set and sample verification statements. The sample code set may include various types of codes, such as endogenous business codes and open-source codes. The sample verification statement is identified from the sample code, and it is a code used to verify the validation of one or more parameters in the sample code, for example, the sample verification statement may be a continuous code block formed by an if statement and a branch statement thereof.

In some embodiments, the training of machine learning model 120 includes a pre-training process and a fine-tuning process. As described above, in the training phase, the model may learn associations between inputs and outputs from the training data. In an implementation related to pre-training, the training phase may include a pre-training phase and a fine-tuning phase. In the pre-training phase, parameters of at least part of the models are updated, and in the fine-tuning phase, parameters of an overall model are further fine-tuned by an output layer required by a specific task.

Given the powerful generalization capabilities of pre-trained models, it is expected that such a pre-trained model may also be provided in the code parameter verification task. In the pre-training process, the machine learning model 120 may be pre-trained based on a sample code set. The sample code set of this process may include endogenous business code and open-source code. In this way, the model may be made to learn a powerful generalization capability by a large number of sample codes. The model obtained by pre-training may continue the fine-tuning process to fine-tune it for the code parameter verification task.

During the fine-tuning process, depending on the needs of the task, the sample code set may be further selected to fine-tune the pre-trained model to obtain a machine learning model 120 that meets the expectations. The parameters of the overall model may also be updated and adjusted by using a corresponding model training algorithm during the fine-tuning. In accordance with embodiments of the present disclosure, the machine learning model 120 is fine-tuned with sample code segments in the sample code from the sample code set and sample verification statements for parameters in the sample code. For example, the sample code set of this process includes only endogenous business code. That is, some sample code segments and verification statements are extracted from the endogenous business code for fine-tuning the machine learning model 120. In this way, the code parameter verification may be tightly coupled with the business logic, that is, a sample code set may be constructed by combining the code of the verification scenarios in the actual business logic, so that the trained machine learning model 120 may identify the business scenarios to be verified in the complex business scenarios, and complete the corresponding verification statement.

In some embodiments, the sample code set used in the pre-training process and the sample code set used in the fine-tuning process may be partially the same or completely different. Because the model has learned much of the knowledge from the sample code set in the pre-training phase, the machine learning model 120 that satisfies expectations may be obtained with a relatively small amount of sample code in the fine-tuning phase. For example, the sample code set is divided into two subsets, one for the pre-training process and another for the fine-tuning process.

In some embodiments, the sample code set employed by the pre-trained process includes full code. The sample code set employed by the fine-tuning phase may include code segments and verification statements extracted from the full code. In this manner, the machine learning model 120 is subjected to supervised learning.

In some embodiments, the sample code segment includes a code segment in the sample code that matches at least one of a plurality of predetermined statement types. The predetermined statement type is a type of statement that needs to be applied in the inference process of the machine learning model 120. As described above, the predetermined statement types include, for example, a reference statement, a function header or a remote procedure call statement.

In some embodiments, the sample code segment also includes a code segment in the sample code that is in a predetermined neighborhood of the sample verification statement. The predetermined neighborhood corresponds to a code range of the target position where the verification statement is to be inserted in the inference process of the machine learning model 120. In the training phase, the code segments in the predetermined neighborhood may be referred to as “pre-verification statements” or “statements before and after verification statements”. In the inference phase, correspondingly, this may be referred to as a “cursor precedence statement” or a “statement before or after a specified position”.

For example, if a “verification precedence statement” is used in the training process of the machine learning model 120, code segments matching the “cursor precedence statement” may be extracted in its inference phase, i.e., the “verification precedence statement” corresponds to the “cursor precedence statement”. In other words, the “Verification Precedence Statement” corresponds to the “Cursor Precedence Statement”. If “statements before and after verification statements” are used in the training process, code segments matching “statements before and after specified position” may be extracted in the inference process, i.e., “statements before and after verification statements” corresponds to “statements before and after specified position”. In other words, “statements before and after the verification statement” corresponds to “statements before and after the specified position”.

FIG. 4 shows a schematic diagram of an example 400 of training and applying a machine learning model 120 according to some embodiments of the present disclosure. The example 400 includes a training process and an inference process for the machine learning model 120. The machine learning model 120 is trained and deployed on a remote device 130. The training of the machine learning model 120 may be performed on the remote device 130, on the terminal device 110, or on any other suitable device (e.g., a cloud device), and embodiments of the present disclosure are not limited thereto. In the inference process, a trained machine learning model 120 may be used to process inputs of code segments from the business scenario and provide outputs of corresponding verification statements. Specific embodiments may be found in the description above.

As described above, the training of the machine learning model 120 includes a pre-training process and a fine-tuning process. During the pre-training process, the model 420 may be trained using the sample code set 410. An important factor affecting the performance of the model is the construction of the training data set. A large quantity and high quality of training data is the basis for pre-training. In embodiments of the present disclosure, the sample code set 410 is expected to include as many sample codes as possible. In some embodiments, the sample code set 410 may be a corpus that includes large-scale open-source code and endogenous business code. For example, the open-source code data may be collected from an open-source code platform, and the endogenous code data may be collected from data sources corresponding to specific business scenarios. In some embodiments, the code data may be pre-processed, for example, by comparing hash values to remove duplicate code in that data. Another example is to remove noisy data from this data. In one example, noisy data is defined as that satisfies the following three categories of rules: 1) a single file is more than IM in length; 2) the average word length per line is more than 100; and 3) the number of characters in the file as a percentage of the number of characters in the file is less than 0.35. Again, for example, removing blank lines in the code in this data, removing code containing specific information, such as hard-coded keys. and/or the like.

The pre-processed sample code set 410 is provided to the model 420. The model 420, for example, is a language model constructed based on Transformer codec. Of course, other model structures, particularly those suitable for pre-training, may be selected to construct the model 420 according to the needs of the actual application. The model 420 has a large number of parameters (e.g., more than one billion), so that it has basic knowledge of code segment and semantics as well as knowledge of the code in business scenarios.

In some embodiments, the pre-training process pre-trains the machine learning model 120 with at least one of a Masked Language Model (MLM) task and a Causal Language Model (CLM) task, e.g., using a pre-processed sample code set 410 to iteratively train the model 420 on the Masked Language Model task and the Causal Language Model task to obtain the pre-trained model 430. In turn, the pre-trained model 430 is fine-tuned in a fine-tuning process to obtain the machine learning model 120. These model tasks enable the model to learn high quality context token embedding (token) and significantly improve downstream performance. Compared to a traditional static verification tool, the workload of developing a verification tool that supports different service scenarios and adapting to a new programming language is greatly saved.

The masking language model may mask a portion of the input sequence (e.g., a specific percentage of words) to train the model 420 to predict the masked words or characters by context. For example, the masking language model replaces or randomly replaces 80% of the words in the input sequence with <MASK> with other words and trains the model 420 to recover the replaced words. Such a masking language model task is also referred to as a “token masking task”. As another example, the masking language model replaces or randomly replaces 80% of the words in the code comments in the input sequence with other words using <MASK> and trains the model 420 to recover the replaced words. Such a masking language modelling task is also known as an “API masking task”.

The causal language model predicts the mask tokens in the input sequence. In the prediction process. each token mask may only see information about the tokens that precede it, but not the ones that follow it. The training goal for model 420 is to predict the token information at the next position based on the token information before it. For example, the probability of occurrence of a combination between words is calculated based on a probability distribution, whereby the causal language model may predict the token information at the current moment based on all previous token information. As an example, the causal language model may replace each word in the input sequence with <MASK> and calculate the probability of occurrence of the word based on the word that appeared above, and later train the model 420 to recover the current word.

In the pre-training process, the reason why the masked language model is used to perform iterative training is that bidirectional dependency information exists in the programming language, for example, a particular statement depends on a variable assigned by a precedence statement, and at the same time, a variable returned by the statement affects a subsequent statement. Thus, it is necessary to use the masked language model to enable the model 420 to learn the bidirectional segment and semantic information embedded in the code. In addition, since the model 420 ultimately needs to be oriented towards the code generation task, the model is trained using the causal language model task. Finally, the model 420 is trained alternately with such two tasks, and a pre-trained model 430 is obtained.

During the fine-tuning process, the pre-trained model 430 is fine-tuned on the constructed verification missing scenario data to provide it with the ability to make up for verification statements. For example, the verification scenario filtering 450 is performed in the endogenous business code, i.e., filtering for code with “verification logic”. In some embodiments, the verification logic includes if branching statements to determine whether a request parameter is valid, and whether the block of statements consists of consecutive lines of code.

The code is divided into independent samples by function granularity, and the “reference statement”, “function header”, “RPC call statement”, “verification precedence statement”, and “statements before and after verification statement” are extracted from the function. Such statements will be matched with code segments in the inference process as predetermined statement types, so that the definitions in the training process correspond to those in the inference process. After obtaining the above statements, they may be concatenated in the natural order of the code and inserted in the first line as a task prompt 470 by prompt project 460 with “[complete validation]”. Finally, the sample data is formatted as “[complete validation]<x><z>”, where <x> is the text associated with the sample code, e.g., the sample code associated with the statement type described above being composed in the natural order of the code. <z> is the output associated with the test target, i.e., the sample verification statement.

It should be noted that in the example of FIG. 4, the format of the sample data containing the task prompts 470 in the fine-tuning process is not the same as the format of the sample data containing the task prompts 330 in the inference process. The former needs to include a sample verification statement in the format <z> to instruct the machine learning model 120 to learn and generate the verification statement. The <z> may include a positive sample verification statement and/or a negative sample verification statement. A positive sample verification statement is a verification statement that is correctly generated. A negative sample verification statement is a verification statement that was incorrectly generated. In addition, the <x> contained in the former may also include positive samples and/or negative samples. The code segments in the positive samples may indicate useful content for code verification, while at least one code segment in the negative samples is useless. Correspondingly, it is necessary to identify each sample code as a positive or negative sample in the prompt project 460 for each sample code as well as the sample verification statement.

In some embodiments, the above sample data format is pre-processed to remove irrelevant code logic, such as to remove duplicate code, to remove noisy data, to remove rows in the code, to remove code containing specific information, and/or the like.

In some embodiments, the pre-training model 430 is fine-tuned trained by a causal language model task to obtain the machine learning model 120. Since the model 420 already knows the segment information of the programming language underlayer during the pre-training process, it can be trained during the fine-tuning process using only the causal language model task.

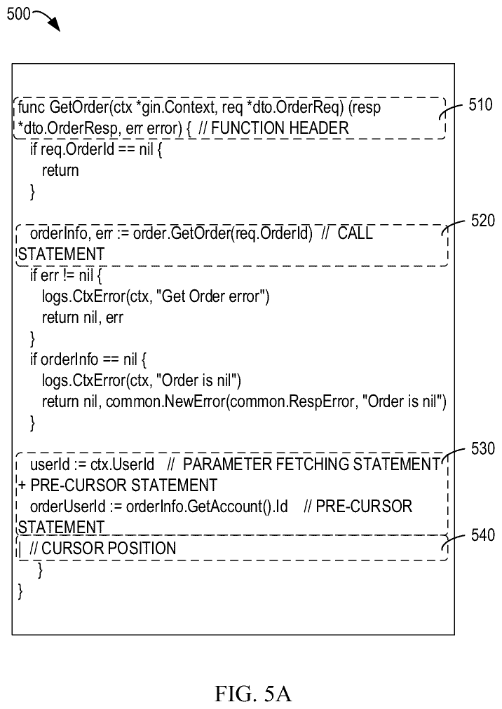

FIG. 5A and FIG. 5B show schematic diagrams of example code 500 for a complementary verification statement, according to some embodiments of the present disclosure. The example code 500 relates to an e-commerce business scenario for obtaining both order information and order owner information. As shown in FIG. 5A, the code 500 is being edited in the code editing page. The terminal device 110 may monitor what is typed in the code editing page, and upon monitoring a code segment matching a predetermined statement type, may provide it to the machine learning model 120 along with a code segment within a predetermined neighborhood in front of the cursor position to generate a verification statement.

In the example of FIG. 5A, the example code 500 includes code segment 510 by code segment 530, the code segment 510 includes a function header, such as the function name “GetOrder”, and input parameters required for the function. The code segment 520 includes an RPC call statement, such as “orderInfo, err:=order.GetOrder(req.OrderId)” (for remotely calling order information). The blank line 540 corresponds to the current cursor position. Accordingly, there may be code segments associated with the cursor precedence statement within a predetermined neighborhood of the current cursor position, such as code segments useful for verifying order ownership. For example, code segment 530 includes a parameter fetching statement+a cursor precedence statement “userId:=ctx.UserId” (for obtaining the current user identity), and a cursor precedence statement “orderUserId:=orderInfo.GetAccount( ).Id” (for getting the order owner).

In the example of FIG. 5A, the terminal device 110 continuously monitors the user's current edit function. In a case where the user types at the cursor position of the blank line 540, the terminal device 110 monitors a “reference statement”, an “RPC call statement”, and a “cursor precedence statement”. The terminal device 110 extracts the matching code segment 510, code segment 520, and code segment 530, and provides these code segments to the machine learning model 120 after concatenating them together in code order, and the machine learning model 120 generates a verification statement (i.e., the code segment 550) that verifies whether the current user is the owner of the order. The terminal device 110 receives such a verification statement (i.e., the code segment 550) and inserts the code segment into the current cursor position, as shown in FIG. 5B. The insertion of the verification statement prevents the occurrence of information leakage caused by overstepping the authority to access another person's order.

In some embodiments, the terminal device 110 may present an insertion prompt control in the user interface 150, such as a motion effect, to remind the user 140 to confirm whether to insert the verification statement. Additionally, or alternatively, the terminal device 110 may also display the verification statement in the user interface 150 and insert it to a corresponding position after receiving a confirmation operation from the user 140, or no longer display the verification statement after receiving a cancellation operation.

In summary, according to various embodiments of the present disclosure, the trained machine learning model 120 is used to generate the verification statements for the code parameters in order to identify and repair verification missing issues for the target code. Further, the machine learning model 120 is pre-trained using the open-source code and the endogenous business code based on the Transformer model, such that the trained machine learning model 120 is capable of identifying business scenarios requiring verification in complex business scenarios and completing the corresponding verification statements. Further, the verification missing sample data based on the task prompt is constructed and fine-tuned on the business code that is tightly coupled with the business. In this way, the correct verification statements may be returned more accurately in a single prediction scenario.

### EXAMPLE APPARATUS AND DEVICE

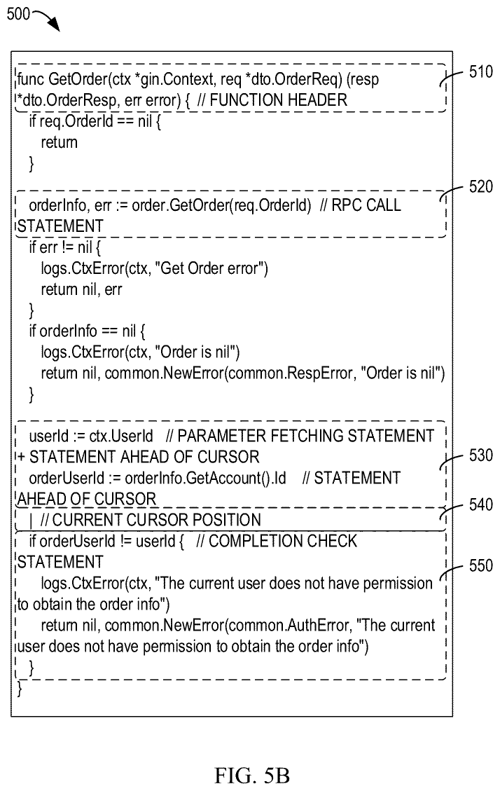

FIG. 6 shows a schematic structural block diagram of an apparatus 600 for code parameter verification, according to certain embodiments of the present disclosure. The apparatus 600 may be implemented as, or included in a terminal device 110. Individual modules/components in the apparatus 600 may be implemented by hardware, software, firmware, or any combination thereof.

As shown, the apparatus 600 includes a request detection module 610 configured to detect a parameter verification request for a target code. The apparatus 600 further includes an extraction module 620 configured to extract at least one code segment from the target code that matches at least one of a plurality of predetermined statement types. The apparatus 600 further includes a generation module 630 configured to generate, based on the at least one code segment, a verification statement for at least one parameter of the code with a trained machine learning model, the verification statement configured to verify validation of the at least one parameter, where the machine learning model is trained based on a sample code set and sample verification statements for parameters of sample code in the sample code set.

In some embodiments, the detection module 610 comprises: an editing detection module configured to detect a parameter verification request in a code editing page for target code; or a file detection module configured to receive a code file-initiated parameter verification request for target code.

In some embodiments, the apparatus 600 further comprises: a control presentation module configured to present an insertion prompt control for a verification statement; and a statement insertion module configured to in response to detecting a predetermined operation for the insertion prompt control, insert the verification statement into the target code.

In some embodiments, the statement insertion module comprises: a position determination module configured to determine a target position of a verification statement to be inserted in a target code, where the position comprises a position of an input cursor or a position specified by a user; and an insert by position module configured to insert the verification statement into a target position identified in the target code.

In some embodiments, the plurality of predefined statement types comprises at least one of: a parameter fetching statement, a function header, or a remote procedure call statement.

In some embodiments, the generation module 630 is further configured to determine a target position of a verification statement to be inserted in the target code: extract a further code segment in a predetermined neighborhood of the target position of the target code: and generate the validation statement based on the at least one code segment and the further code segment with the machine learning model.

In some embodiments, the generation module 630 is further configured to combine the at least one code segment and a task prompt to obtain a prompt input, the task prompt indicating a verification statement generation task: and the prompt input to the machine learning model to obtain the verification statement.

In some embodiments, the at least one code segment includes a plurality of code segments, and the generation module 630 is further configured to concatenate the plurality of code segments in an order of the plurality of code segments in the target code; and combine the plurality of concatenated code segments and the task prompt.

In some embodiments, the training of the machine learning model comprises a pre-training process and a fine-tuning process, where the machine learning model is pre-trained in the pre-training process with the sample code set, and where the machine learning model is fine-tuned in the fine-tuning process with at least one sample code segment in sample code from the sample code set and a sample verification statement for a parameter in the sample code, the at least one sample code segment comprising a code segment of the sample code that matches at least one of the plurality of predetermined statement types.

In some embodiments, the at least one sample code segment further comprises a code segment in the sample code that is in a predetermined neighborhood of the sample verification statement.

In some embodiments, the machine learning model is pre-trained in a pre-training process by masking at least one task of a language model (MLM) task and a causal language model (CLM) task.

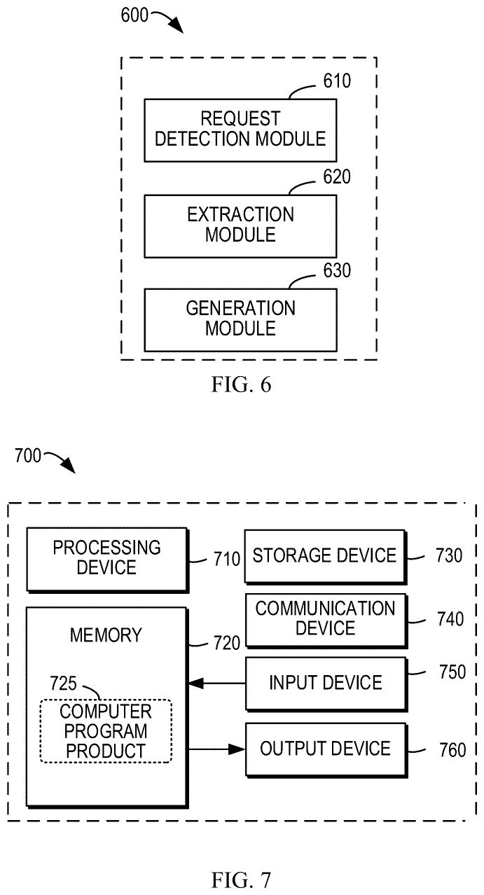

FIG. 7 illustrates a block diagram of an electronic device 700 in which one or more embodiments of the present disclosure may be implemented. It should be understood that the electronic device 700 shown in FIG. 7 is merely exemplary and should not constitute any limitation on the functionality and scope of the embodiments described herein. The electronic device 700 shown in FIG. 7 may be used to implement the terminal device 110 of FIG. 1.

As shown in FIG. 7, the electronic device 700 is in the form of a general-purpose electronic device. Components of the electronic device 700 may include, but are not limited to, one or more processors or processing units 710, a memory 720, a storage device 730, one or more communications units 740, one or more input devices 750, and one or more output devices 760. The processing unit 710 may be an actual or virtual processor and may perform various processes according to programs stored in the memory 720. In a multiprocessor system, a plurality of processing units execute computer executable instructions in parallel, so as to improve the parallel processing capability of the electronic device 700.

The electronic device 700 typically includes a number of computer storage media. Such media may be any available media that are accessible by electronic device 700, including, but not limited to, volatile and non-volatile media, removable and non-removable media. The memory 720 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium such as a flash drive, a magnetic disk, or any other medium that may be used to store information and/or data (e.g., training data for training) and that may be accessed within the electronic device 700.

The electronic device 700 may further include additional removable/non-removable, volatile/nonvolatile storage media. Although not shown in FIG. 7, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 implements communication with other electronic devices through a communication medium. In addition, functions of components of the electronic device 700 may be implemented by a single computing cluster or a plurality of computing machines, and these computing machines can communicate through a communication connection. Thus, the electronic device 700 may operate in a networked environment using logical connections to one or more other servers, network personal computers (PCs), or another network node.

The input device 750 may be one or more input devices, such as a mouse, a keyboard, a trackball, etc. The output device 760 may be one or more output devices, such as a display, a speaker, a printer, etc. The electronic device 700 may also communicate with one or more external devices (not shown) through the communication unit 740 as required. The external device, such as a storage device, a display device, etc., communicate with one or more devices that enable users to interact with the electronic device 700, or communicate with any device (for example, a network card, a modem, etc.) that makes the electronic device 700 communicate with one or more other computing devices. Such communication may be executed via an input/output (I/O) interface (not shown).

According to example implementation of the present disclosure, there is provided a computer-readable storage medium on which a computer-executable instruction or computer program is stored, wherein the computer-executable instructions are executed by a processor to implement the methods described above.

Various aspects of the present disclosure are described herein with reference to the flow chart and/or the block diagram of the method, the device, the apparatus, and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers, or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions comprises a product, which comprises instructions operable to implement various aspects of the functions/acts specified in one or more blocks in the flowchart and/or the block diagrams.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices are operable to implement the functions/acts specified in one or more blocks in the flowchart and/or the block diagrams.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment, or instructions, which includes one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description provides a number of examples, not exhaustive, and is not limited to the disclosed implementations. Without departing from the scope and spirit of the described implementations, many modifications and changes are obvious to ordinary skill in the art. The selection of terms used in this article aims to best explain the principles, practical application, or improvement of technology in the market of each implementation, or to enable others of ordinary skill in the art to understand the various embodiments disclosed herein.

What is claimed is:

1. A method of code parameter verification, comprising:
detecting a parameter verification request for target code;
in response to detecting the parameter verification request, extracting at least one code segment from the target code that matches at least one of a plurality of predetermined statement types; and
generating, based on the at least one code segment, a verification statement for at least one parameter of the code with a trained machine learning model, the verification statement being configured to verify validation of the at least one parameter,
wherein the machine learning model is trained based on a sample code set and sample verification statements for parameters of sample code in the sample code set.

2. The method of claim 1, wherein detecting the parameter verification request comprises:
detecting the parameter verification request in a code editing page of the target code; or
receiving the parameter verification request initiated for a code file of the target code.

3. The method of claim 1, further comprising:
presenting an insertion prompt control for the verification statement; and
in response to detecting a predetermined operation for the insertion prompt control, inserting the verification statement into the target code.

4. The method of claim 3, wherein inserting the verification statement into the target code comprises:
determining a target position of a verification statement to be inserted in the target code, the target position comprising a position of an input cursor or a position specified by a user; and
inserting the verification statement into the target position.

5. The method of claim 1, wherein the plurality of predetermined statement types comprises at least one of the following:
a parameter fetching statement,
a function header, or
a remote procedure call statement.

6. The method of claim 1, wherein generating the verification statement further comprises:
determining a target position of a verification statement to be inserted in the target code;
extracting a further code segment in a predetermined neighborhood of the target position of the target code; and
generating the validation statement based on the at least one code segment and the further code segment with the machine learning model.

7. The method of claim 1, wherein generating the verification statement comprises:
combining the at least one code segment and a task prompt to obtain a prompt input, the task prompt indicating a verification statement generation task; and
providing the prompt input to the machine learning model to obtain the verification statement.

8. The method of claim 7, wherein the at least one code segment comprises a plurality of code segments, and wherein combining the at least one code segment and the task prompt comprises:
concatenating the plurality of code segments in an order of the plurality of code segments in the target code; and
combining the plurality of concatenated code segments and the task prompt.

9. The method of claim 1, wherein the training of the machine learning model comprises a pre-training process and a fine-tuning process,
wherein the machine learning model is pre-trained in the pre-training process with the sample code set, and
wherein the machine learning model is fine-tuned in the fine-tuning process with at least one sample code segment in sample code from the sample code set and a sample verification statement for a parameter in the sample code, the at least one sample code segment comprising a code segment of the sample code that matches at least one of the plurality of predetermined statement types.

10. The method of claim 9, wherein the at least one sample code segment further comprises a code segment in the sample code that is in a predetermined neighborhood of the sample verification statement.

11. An electronic device, comprising:
at least one processing unit; and
at least one memory coupled to the at least one processing unit and storing instructions for execution by the at least one processing unit that, when executed by the at least one processing unit, cause the electronic device to perform acts comprising:
detecting a parameter verification request for target code;
in response to detecting the parameter verification request, extracting at least one code segment from the target code that matches at least one of a plurality of predetermined statement types; and
generating, based on the at least one code segment, a verification statement for at least one parameter of the code with a trained machine learning model, the verification statement being configured to verify validation of the at least one parameter,
wherein the machine learning model is trained based on a sample code set and sample verification statements for parameters of sample code in the sample code set.

12. The electronic device of claim 11, wherein detecting the parameter verification request comprises:
detecting the parameter verification request in a code editing page of the target code; or
receiving the parameter verification request initiated for a code file of the target code.

13. The electronic device of claim 11, wherein the acts further comprise:
presenting an insertion prompt control for the verification statement; and
in response to detecting a predetermined operation for the insertion prompt control, inserting the verification statement into the target code.

14. The electronic device of claim 13, wherein inserting the verification statement into the target code comprises:
determining a target position of a verification statement to be inserted in the target code, the target position comprising a position of an input cursor or a position specified by a user; and
inserting the verification statement into the target position.

15. The electronic device of claim 11, wherein the plurality of predetermined statement types comprises at least one of the following:
a parameter fetching statement,
a function header, or
a remote procedure call statement.

16. The electronic device of claim 11, wherein generating the verification statement further comprises:
determining a target position of a verification statement to be inserted in the target code;
extracting a further code segment in a predetermined neighborhood of the target position of the target code; and
generating the validation statement based on the at least one code segment and the further code segment with the machine learning model.

17. The electronic device of claim 11, wherein generating the verification statement comprises:
combining the at least one code segment and a task prompt to obtain a prompt input, the task prompt indicating a verification statement generation task; and
providing the prompt input to the machine learning model to obtain the verification statement.

18. The electronic device of claim 17, wherein the at least one code segment comprises a plurality of code segments, and wherein combining the at least one code segment and the task prompt comprises:
concatenating the plurality of code segments in an order of the plurality of code segments in the target code; and
combining the plurality of concatenated code segments and the task prompt.

19. The electronic device of claim 11, wherein the training of the machine learning model comprises a pre-training process and a fine-tuning process,
wherein the machine learning model is pre-trained in the pre-training process with the sample code set, and
wherein the machine learning model is fine-tuned in the fine-tuning process with at least one sample code segment in sample code from the sample code set and a sample verification statement for a parameter in the sample code, the at least one sample code segment comprising a code segment of the sample code that matches at least one of the plurality of predetermined statement types.

20. A non-transitory computer readable storage medium having a computer program stored thereon which, when executed by a processor, implements acts comprising:
detecting a parameter verification request for target code;
in response to detecting the parameter verification request, extracting at least one code segment from the target code that matches at least one of a plurality of predetermined statement types; and
generating, based on the at least one code segment, a verification statement for at least one parameter of the code with a trained machine learning model, the verification statement being configured to verify validation of the at least one parameter,
wherein the machine learning model is trained based on a sample code set and sample verification statements for parameters of sample code in the sample code set.
